(19) United States
(12) Patent Application Publication
(10) Pub. No.: US 2020/0198989 A1
(43) Pub. Date: Jun. 25, 2020

(54) DEVICE FOR PROCESSING FLUIDS

(71) Applicants: Paolo BORTOLIN, Valdobbiadene (IT); Albino BERNARDI, Segusino (IT); Marco LUCCHETTA, San Vendemiano (IT)

(72) Inventors: Paolo BORTOLIN, Valdobbiadene (IT); Albino BERNARDI, Segusino (IT); Marco LUCCHETTA, San Vendemiano (IT)

(21) Appl. No.: 16/619,695

(22) PCT Filed: Jun. 5, 2018
(86) PCT No.: PCT/IB2018/054014

§ 371 Date: Dec. 5, 2019

(30) Foreign Application Priority Data
Jun. 7, 2017 (IT) 102017000061933

(51) Int. Cl. C02F 1/00

(52) U.S. Cl. CPC C02F 1/005; C02F 2303/04

(57) ABSTRACT

A device for processing fluids includes an enclosure that contains inside it one or more ducts that have a curvature. The curvature substantially follows the curvature of a golden spiral or a Fibonacci spiral.

### TECHNICAL FIELD

The present disclosure relates to a device for processing fluids, both liquid and aeriform, in the form of gaseous or mixed substances, in particular for food use such as water, carbonated water, sparkling wine or carbonated beer.

### BACKGROUND

Nowadays the problem of treating fluids is very much felt, in particular of treating water for human consumption.

Since water is an essential element for life of organisms, its quality directly influences the biological development of all living beings.

Quality of water is therefore an essential aspect for human consumption, for plant and animal production, and in its daily uses, and also in its use for the production of foods and beverages.

In fact in plant and animal production it is known that high-quality clean water is directly correlated to the quantity of plants and animals produced and to the nutritional value thereof.

In the agriculture industry and in food production, the term fluids means for example milk, fruit juices, beer and wine.

Such fluids are also used as solvents for their ability to enter solid matrices, solubilize salts and other organic and inorganic elements.

In the production of beer, water is the main ingredient used and its chemical and microbiological qualities are essential during production and condition the organoleptic quality of the finished product.

In the production of microorganisms such as yeasts, bacteria, algae and micro-algae and the like, the development means is above all represented by water and its quality is essential to growth, development, and biomass produced.

Therefore various systems are known that are adapted to achieve the purification and increase in quality of water and of fluids in general.

Such conventional systems usually use mechanical filters or treatments that for example use ozone or chemical treatments.

Such conventional solutions have many drawbacks however, such as structural complexity, high cost of installation and maintenance, or the use of chemical substances that may be found in the form of residues in the processed fluids.

### SUMMARY

The aim of the present disclosure is therefore to solve the above mentioned technical problems, eliminating the drawbacks in the cited known art and hence providing a device that makes it possible to improve the quality of water and of fluids, in particular for food use, such as liquids also in the form of gaseous or mixed substances such as water, carbonated water, sparkling wine or carbonated beer, which is structurally simple and which have low implementation and maintenance costs.

Within this aim, the disclosure provides a device that in addition to the foregoing characteristics also adds the characteristic of not leaving any residue of any kind in the treated fluid.

The disclosure provides a device that makes it possible to decrease the oxidizability, the turbidity and the bacterial load of the water, thus improving the chemical and microbiological quality of the fluids proper.

The disclosure also obtains a device that makes it possible to achieve the potentization of the water so that it becomes more vital, with smaller particles that can increase the solvent and absorption capacity.

The disclosure further provides a device that enables the production of fluids for food use, liquid and semi-liquid, with high organoleptic and nutritive qualities and having better filterability.

The disclosure obtains a device that makes it possible to treat water so as to decrease the formation of limescale in the pipes, by reducing the size of the particles.

This aim and these and other advantages which will become better apparent hereinafter are achieved by providing a device for processing fluids, characterized in that it is constituted by an enclosure that contains inside it one or more ducts that have a curvature that substantially follows the curvature of a golden spiral or Fibonacci spiral and which are connected at their ends to a delivery inlet and an outlet for said fluids.

### BRIEF DESCRIPTION OF THE DRAWINGS

Further characteristics and advantages of the disclosure will become better apparent from the detailed description of a particular but not exclusive embodiment thereof, illustrated by way of non-limiting example in the accompanying drawings, wherein:

FIG. 1 is a first perspective view of the assembled disclosure;

FIG. 2 is a first exploded perspective view of the disclosure;

FIG. 3 is a second exploded perspective view of the disclosure;

FIG. 4 is a third exploded perspective view of the disclosure;

FIG. 5 is a fourth exploded perspective view of the disclosure;

FIG. 6 is a plan view of the disclosure without a lid;

FIGS. 7 to 10 are various views of the internal ducts;

FIGS. 11 to 15 show a first variation in which the single duct is bent so as to obtain four turns that reproduce the figure of the complete golden spiral; and

FIGS. 16 to 20 show a second variation in which the single duct is bent so as to obtain four turns of which three reproduce the figure of the complete golden spiral.

### DETAILED DESCRIPTION OF THE DRAWINGS

In the exemplary embodiments that follow, individual characteristics, given in relation to specific examples, may actually be interchanged with other different characteristics that exist in other exemplary embodiments.

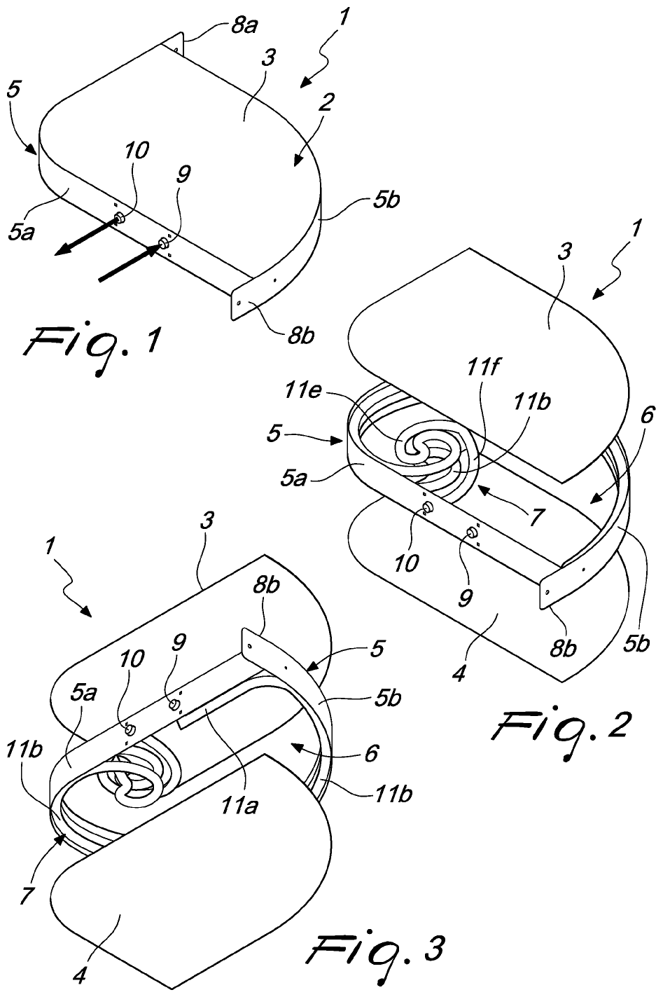

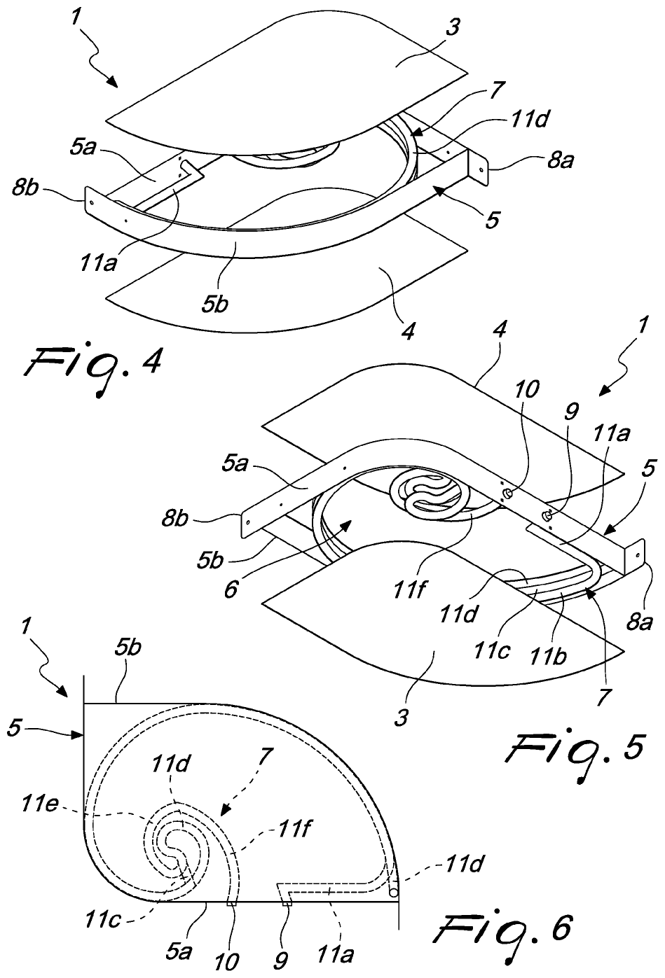

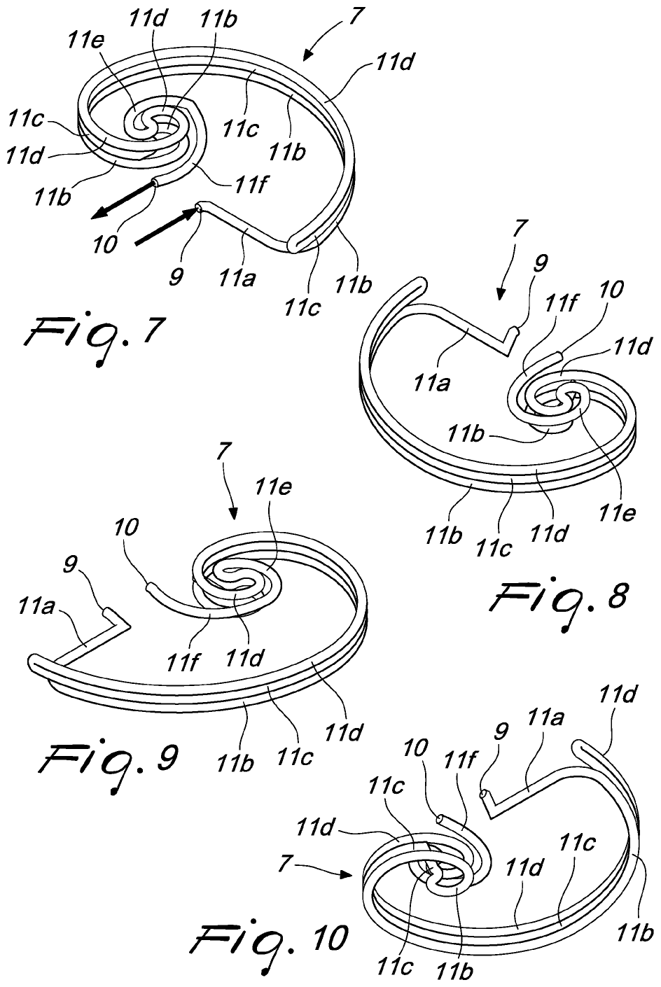

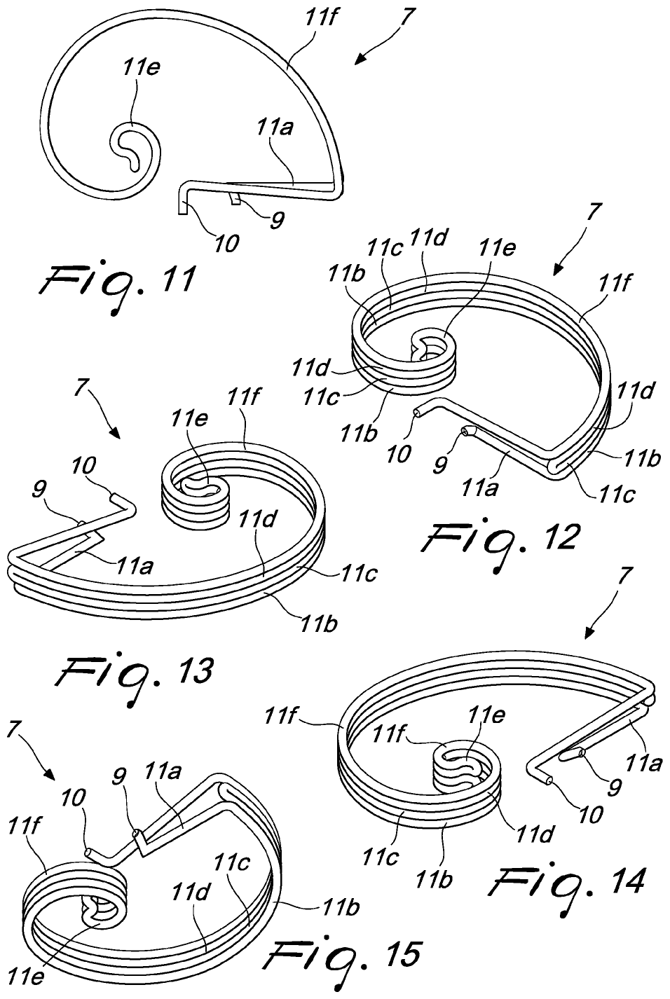

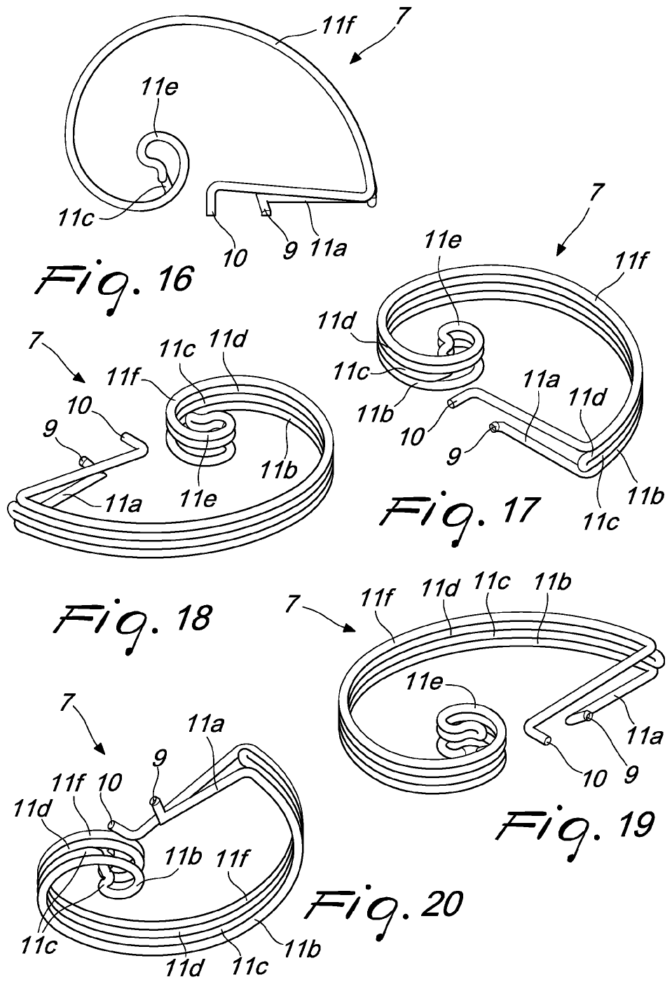

With reference to FIGS. 1-20, the reference numeral 1 indicates a device for processing fluids, such as, by way of example, water, milk, fruit juices, beer, wine, food beverages also in the form of gaseous or mixed substances such as water, carbonated water, sparkling wine or carbonated beer.

The device 1 is constituted by an enclosure 2, which may or may not be hermetic and made of various materials, such as preferably aluminum or steel, and which comprises a lid 3 and a bottom 4 between which a smooth, perforated or absent wall 5 is interposed.

Thus an internal cavity 6 is defined within which one or more ducts 7 are positioned which have a curvature that follows the curvature of a golden spiral.

Each one of the one or more ducts 7 is constituted by a pipe, flexible and bent or rigid and curved or molded and milled so as to follow one or more times the figure of the golden spiral or of the similar Fibonacci spiral.

In this particular embodiment a single duct 7 has been considered, bent so as to follow the figure of the golden spiral multiple times, preferably three times.

In geometry, the golden spiral is a logarithmic spiral with a growth factor “b” with a value equal to “0” (theta), according to the following equation:

r=a·e^{bθ}

or

θ=1/b·ln(r/a)

where “e” is the base of natural logarithms and “a” is an arbitrarily positive real constant.

An approximation of the golden spiral, which is also included in the solution according to the present application, is given by the Fibonacci spiral.

The lid 3 and the bottom 4 preferably have a substantially rectangular shape with two opposite arc-like corners; the wall 5 has a rectangular band-like shape and follows the perimetric shape of the lid 3 and of the bottom 4 and is associated thereto so as to preferably render the inside of the device 1 and therefore the internal cavity 6 hermetic.

The lid 3 and the bottom 4 can be cambered internally and/or externally.

Advantageously the wall 5 has a substantially double-L shape so as to define a first L-shape 5a and a second L-shape 5b, in which the respective end of the shorter wing 8a, 8b of the L may or may not protrude slightly beyond the end of the longer wing and can have the desired shape structure.

At each one of the ends 8a, 8b there can be means for fastening to a wall, such as holes.

At the first L-shape 5a, preferably at the longer wing, there are two openings, advantageously mutually adjacent, for the connection of the delivery inlet 9 for the fluids, and of the outlet 10 for the fluids which are thus made to flow in the duct 7.

The positioning of the delivery inlet 9 and of the outlet 10 shown in the figures can also be mutually swapped.

The duct 7 is constituted preferably by a flexible pipe preferably made of inert steel that is resistant to high temperatures and pressures; such flexible pipe has a diameter comprised between 0.01 mm and 70,000 mm, preferably a diameter that can vary from 5 mm to 500 mm or even preferably from 10 mm to 80 mm. As indicated, the duct 7 is bent so as to obtain three turns, two of which reproduce the figure of the complete golden spiral.

Thus, starting from the delivery inlet 9, a first portion 11a, which extends straight in the opposite direction from the outlet 10, followed by a second portion 11b, which extends on the same plane following the shape of the golden spiral, are defined.

The second portion 11b is followed by a third portion 11c which extends on a different (upper) plane, again following the form of the golden spiral until approximately the blending between the first portion 11a and the second portion 11b.

The blending between the second portion 11b and the third portion 11c constitutes a short portion that does not follow the shape of the golden spiral.

In substance, the second turn of the spiral (which corresponds to the third portion 11c) starting from below is not complete because it is blended by the first turn of the spiral so as to avoid the narrowest part of the spiral. In this region the third portion 11c is followed by a fourth portion 11d which extends on an upper plane, following the shape of the golden spiral.

The fourth portion 11d is followed, substantially on a same plane, by a fifth portion 11e which describes only a part of the spiral until it blends with a sixth portion 11f which blends with the underlying outlet 10.

It has been found that when fluids are made to flow inside the duct 7 they come out purified, by virtue of the curvature that follows the curvature of a golden spiral, with a vitalization and potentization of such fluids having occurred.

For example if water is used, it has been found that the water, once treated, shows a decrease in turbidity, a decrease in oxidizability, a decrease in the total bacterial load, a decrease in the insoluble salts with decreased limescale on the surfaces of and inside the apparatuses, greater clarification of the fluids and greater vitality measured using a BOVIS Biometer.

Such advantages have been proven by way of tests that have compared samples of water originating from several wells, as drawn, and samples of the same water after passing through the device 1, with measurements repeated over time, in particular:
in order to determine the turbidity, the official APAT CNR IRSA 2110 Man 29 2003 method was used and a decrease in turbidity was found in the samples treated with the device 1 comprised between (60-90)%;
in order to determine the oxidizability, the reference analytic method was used for the water intended for human consumption, published in the ISTISAN Report 2007/31 and a decrease in oxidizability was found in the samples treated with the device 1 of 50% on average;
in order to determine the bacterial load, an analytical procedure was used which is adapted to verify the presence of microorganisms by counting the colonies of all microorganisms (bacteria, yeasts and funguses) grown in a mat of plate count agar (technique of inclusion in agar), analyzing known sample aliquots mixed with the substrate kept loose and subsequently allowed to solidify in Petri dishes and conducting the tests both at temperatures equal to 36° C. to highlight mesophilic microorganisms, and at temperatures equal to 22° C. to highlight psychrophilic microorganisms, and a decrease in microorganisms was found in the samples treated with the device 1 comprised between (50-90)%;
in order to determine the size of the water particles, a Dynamic Light Scattering (DLS) analysis was carried out and an overall decrease in the size of the water particles was found in the samples treated with the device 1, with the disappearance of particles with dimensions between 1,000 nm and 10,000 nm and a greater concentration of particles smaller than 100 nm.

It has further been found through experimentation that water, after passing through the device 1, brought to a temperature lower than 0° C., forms a solid state that is generally more transparent than the ice formed using the same but untreated water; after passing through the device 1, the water modifies the shape structure of its hardness, showing a decrease in the particle size of salts, in particular of calcium carbonates.

Thus it has been found that the disclosure fully achieves the intended aim and objects, a device having been obtained that makes it possible to improve the characteristics of fluids such as for example well water and/or water from the water mains which, after passing through the ducts 7, is cleaner, clearer, and brighter, and the particles in it decrease in size resulting in a decrease in the formation of limescale in pipes and in the agricultural, industrial and domestic systems that use water.

The potentization carried out on the fluids by the present disclosure has further been found to result in an increase in the germination of seeds soaked with the treated water, an increase in vigor in plants, and better health in animals and humans.

Naturally the disclosure is susceptible of numerous modifications and variations, all of which are within the scope of the appended claims.

Thus the number of ducts 7 or their diameter or their arrangement or the number of reiterations of the shape of the golden spiral imparted to the various portions can vary according to specific requirements, such as the type of fluid used or the pressure of said fluid or the flow-rate of said fluid or the temperature of said fluid or in order to increase the power of the device.

The important thing is that in plan view the ducts 7 have a curvature that follows the curvature of a golden spiral or a Fibonacci spiral.

Thus the arrangement of the delivery inlet 9 and of the outlet 10 can also be obtained by having them on the same plane or on different planes.

FIGS. 11 to 15 show a first variation in which the single duct 7 is bent so as to obtain four turns that reproduce the figure of the complete golden spiral.

In such solution the fifth portion 11e and the subsequent sixth portion 11f together follow a curvature that fully duplicates that of a golden spiral until the sixth portion 11f blends with the outlet 10.

In this solution the outlet 10 and the delivery inlet 9 lie on different planes.

FIGS. 16 to 20 show a second variation in which the single duct 7 is bent so as to obtain four turns of which three reproduce the figure of the complete golden spiral.

Thus, starting from the delivery inlet 9, a first portion 11a, which extends in the opposite direction from the outlet 10, followed by a second portion 11b, which extends on the same plane following the shape of the golden spiral, are defined.

The second portion 11b is followed by a third portion 11c which extends on a different (upper) plane, again following the form of the golden spiral until approximately the blending between the first portion 11a and the second portion 11b.

The blending between the second portion 11b and the third portion 11c constitutes a short portion that does not follow the shape of the golden spiral.

In substance, the second turn of the spiral (which corresponds to the third portion 11c) starting from below is not complete because it is blended by the first turn 11b of the spiral so as to avoid the narrowest part of the spiral.

From the third portion 11c, the duct follows the shape of the golden spiral until it blends with the fourth portion 11d which will follow the spiral shape up to the center.

The fourth portion 11d, conveniently blended, is followed by the fifth portion 11e and the subsequent sixth portion 11f and together they follow a curvature that fully duplicates that of a golden spiral until the sixth portion 11f blends with the outlet 10.

The outlet 10 and the delivery inlet 9 lie on the same plane, the delivery inlet 9 ending with a portion that is slightly inclined with respect to the corresponding portion of the outlet 10.

Naturally the materials used as well as the dimensions of the individual components of the disclosure may be more relevant according to specific requirements.

The characteristics indicated above as advantageous, convenient or the like, may also be missing or be substituted by equivalent characteristics.

The disclosures in Italian Patent Application No. 102017000061933 from which this application claims priority are incorporated herein by reference.

1.-12. (canceled)

13. A device for processing fluids, the device comprises: an enclosure that contains inside it one or more ducts having a curvature that substantially follows the curvature of a golden spiral or a Fibonacci spiral and which are connected at their ends to a delivery inlet and an outlet for said fluids.

14. The device according to claim 13, wherein said enclosure comprises a lid and a bottom, between which a smooth, perforated wall is interposed so as to define an internal cavity inside which said one or more ducts have a curvature that totally or mostly follows the curvature of a golden spiral or a similar Fibonacci spiral are arranged.

15. The device according to claim 14, wherein said lid and said bottom have a substantially rectangular shape with two opposite arc-shaped corners, said wall having a rectangular shape and following the perimetric shape of said lid and said bottom.

16. The device according to claim 13, wherein said wall has a double-L shape, so as to define a first L-shape and a second L-shape, in which a respective end of a shorter wing may protrude slightly beyond an end of a longer wing, at each one of said ends there being means for fastening to a wall.

17. The device according to claim 16, wherein said first L-shape there are, at the longer wing, two mutually adjacent openings for the connection of the delivery inlet for said fluids, and of the outlet for said fluids, which are made to flow in said one or more ducts.

18. The device according to claim 13, wherein each one of said one or more ducts is constituted by a pipe, said pipe being flexible and bent, rigid and curved, or molded and milled configured to follow one or more times the figure of the golden spiral or of the Fibonacci spiral configured to define, starting from said delivery inlet, a first portion extending straight in an opposite direction from said outlet, followed by a second portion extending on a same plane following the shape of said golden spiral.

19. The device according to claim 18, wherein said second portion is followed by a third portion extending on an upper different plane, following the shape of said golden spiral or said Fibonacci spiral until there is blending between said first portion and said second portion, in this region said third portion being followed by a fourth portion extending on an upper plane following the shape of said golden spiral or said Fibonacci spiral.

20. The device according to claim 19, wherein said fourth portion is followed, on a same plane, by a fifth portion extending only for part of said spiral until said fourth portion blends with a sixth portion which blends with said underlying outlet.

21. The device according to claim 13, wherein said delivery inlet and outlet for said fluids are mutually swapped and lie on a same plane or on different planes.

22. The device according to claim 20, wherein said one or more ducts are bent configured to obtain four turns to reproduce the figure of the golden spiral, said fifth portion and said sixth portion together following a curvature that fully duplicates said golden spiral until said sixth portion blends with said outlet.

23. The device according to claim 13, wherein said one or more ducts are bent so as to obtain four turns, three of which reproduce the figure of said golden spiral.

24. The device according to claim 13, wherein said one or more ducts are bent so as to obtain three turns, of which two reproduce the figure of said golden spiral.
